(19) United States
(12) Patent Application Publication
(10) Pub. No.: US 2008/0122360 A1
(43) Pub. Date: May 29, 2008

(54) PLASMA DISPLAY PANEL AND METHOD OF MANUFACTURING THE PLASMA DISPLAY PANEL

(75) Inventor: Chul-Hong KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/850,889

(22) Filed: Sep. 6, 2007

(30) Foreign Application Priority Data
Nov. 27, 2006 (KR) 10-2006-0117840

(51) Int. Cl. H01J 17/49; H01J 9/00

(52) U.S. Cl. 313/584; 445/24

(57) ABSTRACT

A plasma display panel and a method of manufacturing the plasma display panel in which the plasma display panel includes first and second substrates facing each other and spaced apart from each other, barrier ribs disposed between the first and second substrates and defining discharge cells, an address electrode formed on the first substrate and extending in a first direction, and first and second electrodes formed on the second substrate and extending in a second direction crossing the first direction. Each of the first and second electrodes includes a transparent electrode formed on the second substrate and a bus electrode formed on the transparent electrode. The bus electrode may be formed of a material including white crystalline silver (Ag) and a black material.

### CROSS-REFERENCE TO RELATED APPLICATIONS

This application claims the benefit of Korean Application No. 2006-117840, filed Nov. 27, 2006 in the Korean Intellectual Property Office, the disclosure of which is incorporated herein by reference.

### BACKGROUND OF THE INVENTION

1. Field of the Invention

Aspects of the present invention relate to a plasma display panel and a method of manufacturing the plasma display panel and, more particularly, to a plasma display panel having a black/white integrated bus electrode that is formed through a dry process, and a method of manufacturing the plasma display panel.

2. Description of the Related Art

Generally, a plasma display panel (PDP) is a display device that can display an image using red, green, and blue visible light created by exciting phosphors using vacuum ultraviolet (VUV) rays emitted from plasma generated by the gas discharge, a chassis base to support the plasma display panel, and a plurality of printed circuit board assemblies mounted on the chassis base that control the display of the image.

For example, in an alternating current (AC) plasma display panel, address electrodes are formed on a rear substrate. The address electrodes are covered by a dielectric layer. Barrier ribs are arranged in a stripe pattern on the dielectric layer between the address electrodes so that the address electrodes correspond to discharge cells defined by the barrier ribs. Red, green, and blue phosphor layers are formed on the barrier ribs. A plurality of display electrodes, each having a pair of sustain and scan electrodes, are arranged on a surface of the front substrate between the front substrate and the rear surface. The display electrodes extend in a direction crossing the address electrodes. The display electrodes are covered by a dielectric layer and an MgO protective layer. Discharge cells are formed at regions where the address electrodes formed on the rear substrate cross the sustain and scan electrodes formed on the front substrate. Millions or more of the discharge cells are arranged in a matrix pattern in the plasma display panel.

Each of the sustain and scan electrodes includes a transparent electrode and a bus electrode. In order to form the bus electrode, a black layer is printed on the front substrate and dried. Then, a white layer is printed on the black layer and dried. Finally, light exposing, developing, and firing processes are performed.

The above-described bus electrode forming method includes a wet process and thus the overall forming process is complicated and time-consuming. Furthermore, the method uses environmentally harmful materials. In order to overcome such problems, a dry process to replace the wet process has been proposed.

### SUMMARY OF THE INVENTION

Aspects of the present invention provide a plasma display panel, in which bus electrodes of sustain and scan electrodes are formed in a black/white integrated structure through a dry process, and provides a method of manufacturing the plasma display panel.

According to aspects of the present invention, a plasma display panel includes first and second substrates facing each other and spaced apart from each other, barrier ribs disposed between the first and second substrates and defining discharge cells, an address electrode formed on the first substrate and extending in a first direction, and first and second electrodes formed on the second substrate and extending in a second direction crossing the first direction. Each of the first and second electrodes includes a transparent electrode formed on the second substrate and a bus electrode formed on the transparent electrode. The bus electrode may be formed of a material including a white crystalline silver (Ag) and a black material.

According to aspects of the present invention, the bus electrode may include 95% by weight or more of the Ag. The bus electrode may include less than 5% by weight of binder. The bus electrode may have a thickness ranging from 0.5 μm to 1 μm. The bus electrode may include at least one of a cobalt oxide and a ruthenium oxide.

According to aspects of the present invention, a method of manufacturing a plasma display panel includes forming an address electrode, a dielectric layer, a barrier rib, and a phosphor layer on a first substrate, forming a transparent electrode, a bus electrode, a dielectric layer, and a protective layer on a second substrate, sealing the first and second substrates together, exhausting a remaining gas from a space between the first and second substrates, and filling a discharge gas in the space between the first and second substrates. The forming of the bus electrode on the second substrate may include forming a photopolymer pattern on the second substrate and forming a bus electrode pattern on the photopolymer pattern.

According to aspects of the present invention, the forming of the photopolymer pattern may include laminating a photopolymer sheet on the second substrate, exposing the laminated photopolymer sheet in a predetermined pattern, and removing a cover film from the photopolymer sheet. The laminating of the photopolymer sheet may be performed by applying heat and pressure using a roller.

According to aspects of the present invention, the forming of the bus electrode pattern may include laminating a bus electrode film sheet on the exposed photopolymer pattern, removing a carrier film from the bus electrode film sheet so that a first conductive portion of the bus electrode film sheet corresponding to the non-exposed portion of the photopolymer pattern is removed together with the carrier film and a second conductive portion of the bus electrode film sheet corresponding to the exposed portion of the photopolymer pattern remains attached to the exposed portion, and firing the second conductive portion and the photopolymer to form a bus electrode pattern using the second conductive portion. The laminating of the bus electrode film is performed by applying pressure using a roller.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic exploded perspective view of a plasma display panel according to an embodiment of the present invention;

FIG. 2 is a cross-sectional view taken along line II-II of FIG. 1;

FIG. 3 is a top plane view of an arrangement of discharge cells and electrodes according to aspects of the present invention;

FIG. 4 is a flowchart illustrating a method of manufacturing a plasma display panel according to aspects of the present invention;

FIGS. 5A, 5B, and 5C illustrate a process for forming a photo-polymer on a front substrate according to aspects of the present invention; and

FIGS. 6A, 6B, and 6C illustrate a process for forming a bus electrode on a front substrate according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Aspects of the present invention may, however, be embodied in different forms and should not be construed as limited to the embodiments set forth herein. When it is mentioned that a layer or an electrode is said to be “disposed on” or “formed on” another layer or a substrate, the phrases mean that the layer or electrode may be directly formed on the other layer or substrate, or that a third or additional layer may be disposed therebetween. In addition, the thickness of layers and regions may be exaggerated for clarity.

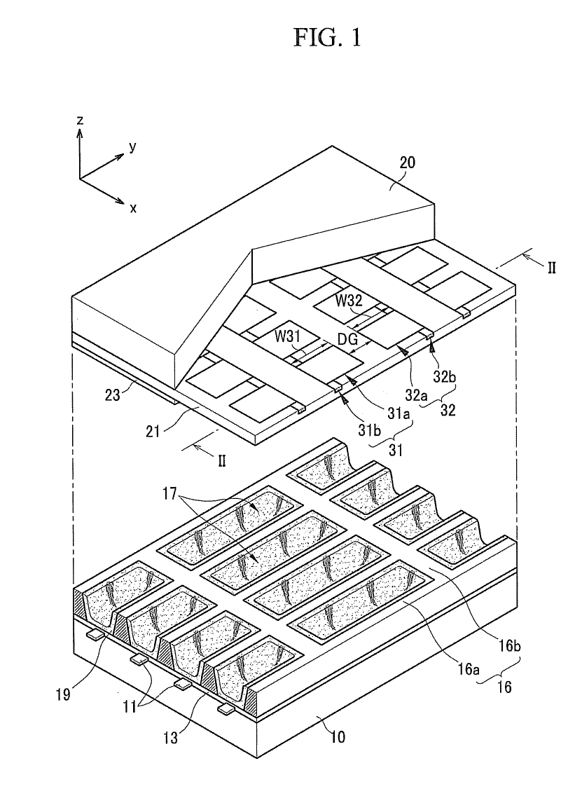

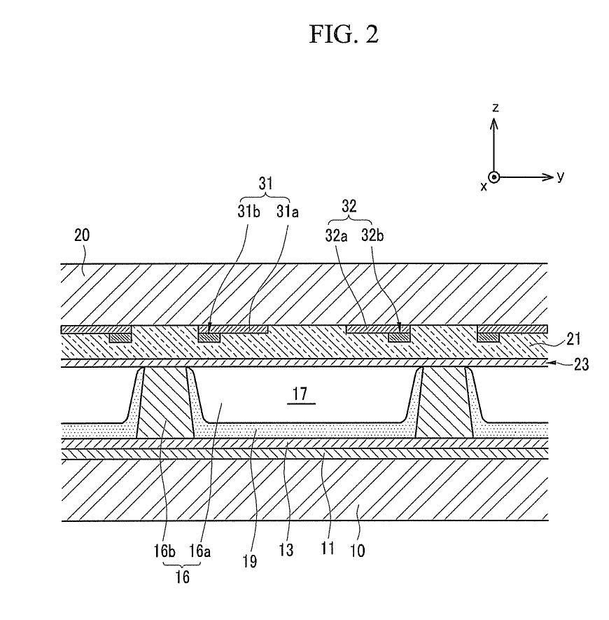

FIG. 1 is a schematic exploded perspective view of a plasma display panel according to aspects of the present invention, and FIG. 2 is a cross-sectional view taken along line II-II of FIG. 1. Referring to FIGS. 1 and 2, a plasma display panel includes first and second substrates (hereinafter, “rear and front substrates”) 10 and 20 facing each other at a predetermined distance and sealed together, and barrier ribs 16 disposed between the rear and front substrates 10 and 20. The barrier ribs 16 are formed with a predetermined height between the rear and front substrates 10 and 20 to define a plurality of discharge cells 17. The discharge cells 17 are filled with a discharge gas (e.g., a mixture of gases including helium (He), neon (Ne), and xenon (Xe)) to create vacuum ultraviolet waves using a gas discharge. The discharge cells 17 have phosphor layers 19 for absorbing the vacuum ultraviolet waves to thereby emit visible light.

In order to effect the gas discharge, the plasma display panel includes address electrodes 11, first electrodes 31 (hereinafter, “sustain electrodes”), and second electrodes 32 (hereinafter, “scan electrodes”). Each of the sustain and scan electrodes 31 and 32 includes a transparent electrode 31a and 32a and a bus electrode 31b and 32b. The address electrodes, sustain electrodes, and scan electrodes 11, 31, and 32 are disposed between the rear and front substrates 10 and 20 to correspond to the discharge cells 17.

The address electrodes 11 extend in a first direction (the y-axis in the drawings) on an inner surface of the rear substrate 10 to correspond to the discharge cells 17 that are adjacent to each other along the y-axis. In addition, the address electrodes 11 are arranged in parallel across the inner surface of the rear substrate 10 and spaced apart from adjacent address electrodes 11 in a second direction (the x-axis in the drawings) crossing the first direction. The discharge cells 17 are adjacent to each other in the second direction. Although the first and second directions are illustrated as the y-axis and the x-axis, the first and second directions are not limited thereto such that the first and second directions need only cross and correspond to the discharge cells 17.

The address electrodes 11 are covered by a first dielectric layer 13 and are deposited on an inner surface of the rear substrate 10. The dielectric layer 13 prevents the address electrodes 11 from being damaged by preventing positive ions or electrons from directly colliding with the address electrodes 11, and the dielectric layer 13 generates and accumulates wall charges to increase the gas discharge in the discharge cells 17. As the address electrodes 11 are arranged on the rear substrate 10 and do not to interfere with the irradiation of the visible light toward the front substrate 20, the address electrodes 11 may be formed of a non-transparent material. The address electrodes 11 may be formed of metal that has excellent electric conductivity.

The barrier ribs 16 are provided on the first dielectric layer 13 to actually define the discharge cells 17. For example, the barrier ribs 16 include first barrier members 16a extending along the first direction (the y-axis) and second barrier members 16b extending along the second direction (the x-axis) between the first barrier members 16a. The first and second barrier members 16a and 16b form the discharge cells 17 to have a matrix structure.

Alternatively, the barrier ribs 16 may include first barrier members 16a extending in the first direction along the y-axis and spaced apart from each other in the second direction along the x-axis such that the first barrier members 16a form the discharge cells 17 in a stripe structure. That is, the discharge cells 17 may be open in the first direction along the y-axis such that the discharge cells 17 adjacent to other discharge cells 17 in the first direction are not separated by the second barrier rib members 16b. However, the discharge cells 17 and the barrier ribs 16 are not limited to the above-described structures such that the discharge cells 17 may be formed of different shapes, such as triangles or circles, and the barrier ribs 16 may include protrusions that extend from the barrier ribs 16 into the discharge cells 17. And, the first and second barrier rib members 16a and 16b need not be perpendicular as illustrated in FIG. 1 but need only cross.

The barrier ribs 16 as illustrated in FIG. 1 define the discharge cells 17 in the matrix structure. From this matrix structure, when the second barrier members 16b are removed, the discharge cells formed in the stripe structure by the first barrier members 16a can be formed. Therefore, a drawing illustrating the discharge cells formed in the stripe structure will be omitted herein.

The phosphor layers 19 are formed in each discharge cell 17 and are formed by printing or depositing fluorescent paste on a sidewall of the barrier rib 16 and a surface of the first dielectric layer 13. The printed or deposited fluorescent paste is then dried and baked. The phosphor layers 19 in the discharge cells 17 adjacent in the first direction arranged along the y-axis are formed of phosphors of an identical color. In addition, the phosphor layers 19 formed in the discharge cells 17 adjacent in the second direction are arranged along the x-axis are formed of red, green, and blue phosphors R, G and B and are arranged alternately. However, the arrangement of the red, green, and blue phosphors R, G, and B are not limited thereto such that the red, green, and blue phosphors R, G, and B need only be capable of displaying an image when excited by the gas discharges in the discharge cells 17.

The sustain and scan electrodes 31 and 32 are provided on an inner surface of the front substrate 20 to form surface discharge structures corresponding to the respective discharge cells 17, which induce the gas discharge in the discharge cells 17.

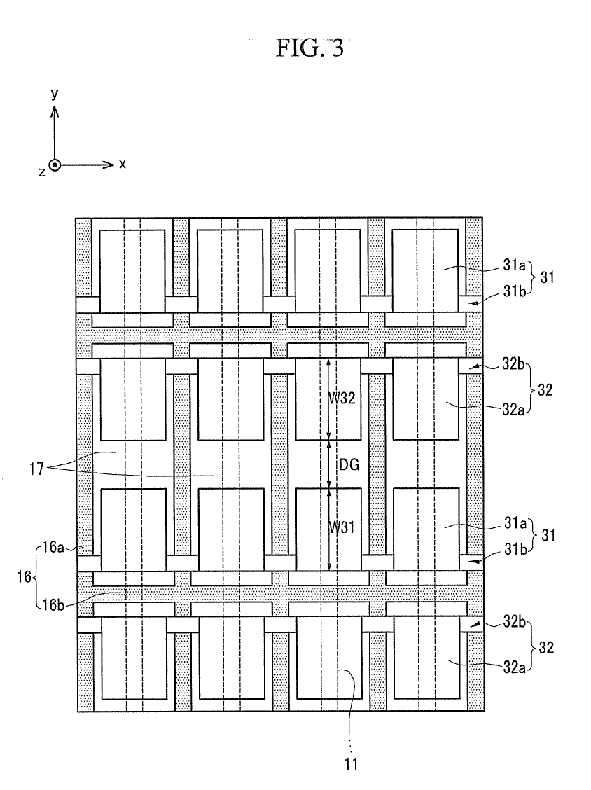

Referring to FIG. 3, the sustain and scan electrodes 31 and 32 extend along the second direction (the x-axis) crossing the address electrodes 11. Each of the sustain and scan electrodes 31 and 32 includes a transparent electrode 31a and 32a and a bus electrode 31b and 32b. The bus electrodes 31b and 32b apply a voltage signal to the transparent electrode 31a and 32a. The transparent electrodes 31a and 32a extend along the surface of the front substrate 20 (of FIG. 1) into an area corresponding to the discharge cells 17 so as to provide for the accumulation of surface charges on the protective layer 23 to effect surface discharges in the discharge cells 17. The transparent electrodes 31a and 32a are formed of a transparent material such as indium tin oxide (ITO) to increase an aperture ratio of the discharge cells 17. The bus electrodes 31b and 32b are formed of metal that has excellent electric conductivity to compensate for the high electric resistance of the transparent electrodes 31a and 32a.

The transparent electrodes 31a and 32a extend in the second direction along the y-axis and have respective widths W31 and W32. The widths W31 and W32 of the transparent electrodes 31a and 32a extend in the second direction along the y-axis. The transparent electrodes 31a and 32a extend by the length of the widths W31 and W32 from opposite ends of a corresponding discharge cell 17 toward a central portion of the corresponding discharge cell 17 to form the surface discharge structure and a discharge gap DG therebetween. As such, the transparent electrodes 31a and 32a extend between the first barrier rib members 16a in the first direction along the y-axis from adjacent second barrier rib members 16b toward the central portion of the corresponding discharge cell 17. The bus electrodes 31b and 32b are formed on the respective transparent electrodes 31a and 32a along opposite ends of the corresponding discharge cell 17. The bus electrodes 31b and 32b extend in the second direction along the x-axis at the opposite ends of the discharge cells 17. Therefore, when voltages are applied to the bus electrodes 31b and 32b, the voltages are applied to the transparent electrodes 31a and 32a connected respectively thereto. Alternatively, the transparent electrodes 31a and 32a may be connected to transparent electrodes 31a and 32a adjacent in the second direction along the x-axis. However, such structure is not shown in the figures.

Referring again to FIGS. 1 and 2, the sustain and scan electrodes 31 and 32 correspond to the discharge cells 17 and cross the address electrodes 11. The sustain and scan electrodes 31 and 32 are disposed to face each other on an inner surface of the front substrate 20 and are covered by a second dielectric layer 21. The second dielectric layer 21 protects the sustain and scan electrodes 31 and 32 from the gas discharge and forms and accumulates wall charges.

The second dielectric layer 21 is covered by a protective layer 23. For example, the protective layer 23 protects the second dielectric layer 21 and increases an emission amount of secondary electrons.

When the plasma display panel is driven, a reset discharge is effected by a reset pulse applied to the scan electrodes 32 during a reset period. In a scan period (addressing period) that follows the reset period, an address discharge occurs by a scan pulse applied to the scan electrodes 32 and an address pulse is applied to the address electrodes 11. Then, in a sustain period, a sustain discharge is effected by a sustain pulse that is alternately applied to the sustain and scan electrodes 31 and 32.

The sustain and scan electrodes 31 and 32 apply the sustain pulse required for the sustain discharge. The scan electrodes 32 apply the reset and scan pulses. The address electrodes 11 apply the address pulse. The sustain electrodes, scan electrodes, and address electrodes 31, 32, and 11 apply different pulses to the discharge cells 17 depending upon voltage waveforms respectively applied thereto. Therefore, the sustain electrodes, scan electrodes, and address electrodes 31, 32, and 11 are not limited to applying the above described pulses.

The plasma display panel selects discharge cells 17 that will be turned on by the address discharge occurring by the interaction between the address and scan electrodes 11 and 32 and drives the selected discharge cells 17 using the sustain discharge between the sustain and scan electrodes 31 and 32 to thereby display an image.

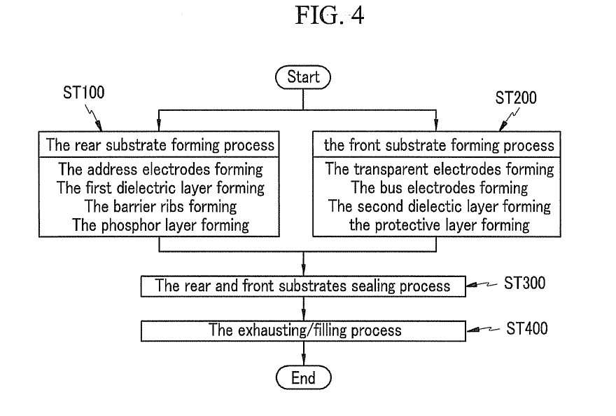

According to aspects of the current invention, in order to simplify the process for forming the bus electrodes 31b and 32b, the bus electrodes 31b and 32b are formed in a black/white integrated structure through a dry process. The structure of the bus electrodes 31b and 32b will be made clear through the description of a plasma display panel manufacturing process that will be described with reference to FIGS. 4 through 6.

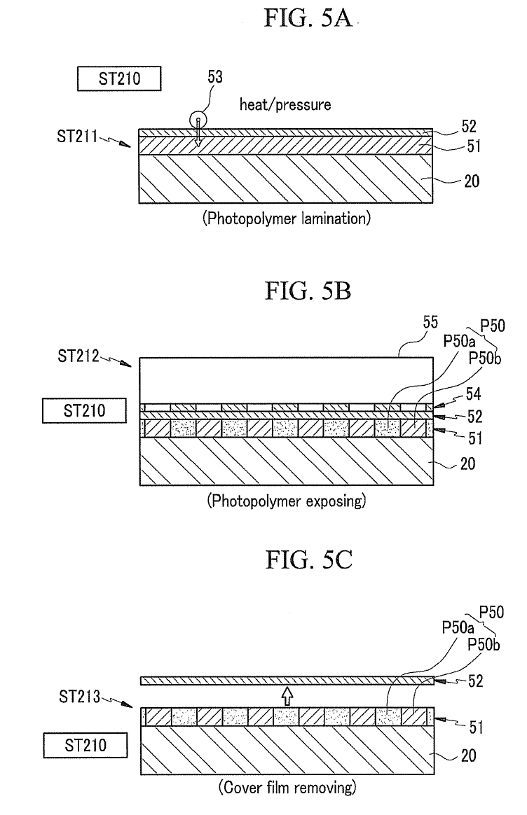

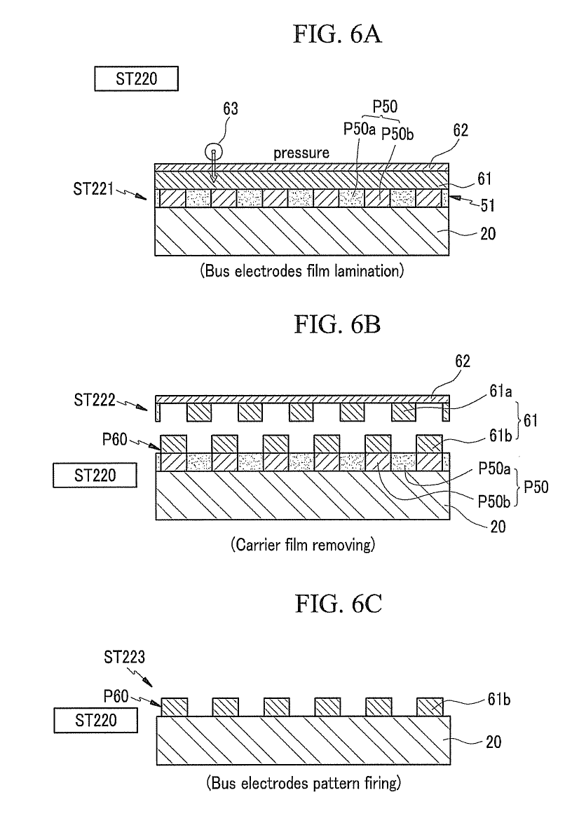

FIG. 4 is a flowchart illustrating a method of manufacturing a plasma display panel according to aspects of the present invention. FIGS. 5A, 5B, and 5C illustrate a process for forming a photo-polymer on the front substrate according to aspects of the present invention. FIGS. 6A, 6B, and 6C illustrate a process for forming a bus electrode on a front substrate according to aspects of the present invention.

Referring to FIG. 4, a method of manufacturing the plasma display panel includes a rear substrate forming process ST100, a front substrate forming process ST200, a sealing process ST300, and an exhausting/filling process ST400.

In the rear substrate forming process ST100, the address electrodes 11, the first dielectric layer 13, the barrier ribs 16, and the phosphor layer 19 are formed on the rear substrate 10. In the front substrate forming process ST200, the transparent electrodes 31a and 32a, the bus electrodes 31b and 32b, the second dielectric layer 21, and the protective layer 23 are formed on the front substrate 20. In the sealing process ST300, the rear and front substrates 10 and 20 are sealed together. In the exhausting/filling process ST400, gas remaining in the spaces defined by the discharge cells 17 between the rear and front substrates 10 and 20 are exhausted and a discharge gas is filled in the discharge cells 17 as defined by the barrier ribs 16.

The bus electrode forming process of FIG. 4 includes a process ST210 for forming a photopolymer 50 having a predetermined pattern on the front substrate 20 (see FIGS. 5A, 5B, and 5C) and a process for forming a bus electrode pattern P60 on a pattern P50 of the photopolymer 51 (see FIGS. 6A, 6B, and 6C).

Referring to FIGS. 5A, 5B, and 5C, the photopolymer forming process ST210 includes a process ST211 for laminating a sheet of a photopolymer 51 on the front substrate 20 (FIG. 5A), a process ST212 for exposing a predetermined pattern of the photopolymer 51 to light (FIG. 5B), and a process ST213 for removing a cover film 52 attached on the photopolymer 51 (FIG. 5C). For clarity in illustration, the transparent electrodes 31a and 32a are not shown in FIG. 5.

In the photopolymer lamination process ST211 of FIG. 5A, the photopolymer 51 is laminated on the front substrate 20 by applying heat and pressure to the sheet of the photopolymer 51 using a roller 53. The heat and pressure are applied to a cover film 52 that covers the sheet of the photopolymer 51 to adhere the sheet of the photopolymer 51 to the front substrate 20. The cover film 52 remains on the sheet of the photopolymer 51 while the photopolymer 51 is exposed to ultraviolet light. As such, the cover film 52 transmits at least ultraviolet radiation therethrough.

In the photopolymer exposing process ST212 of FIG. 5B, a photomask 54 is disposed on the cover film 52, which covers the photopolymer 51, and ultraviolet light is irradiated to expose a pattern P50 of the photopolymer 51, the pattern P50 being identical to the arrangement of the bus electrodes 31b and 32b. Exposure of the photopolymer 51 to the ultraviolet light causes the photopolymer 51 to cure. As such, only the exposed portions P50b of the photopolymer 51 cure to form the bus electrodes 31b and 32b while the non-exposed portions P50a of the photopolymer 51 are not cured and are later removed.

With reference to FIG. 5C, when the cover film 52 is removed, the photopolymer 51 remains on the front substrate 20. That is, the pattern P50 of the photopolymer 51 includes the non-exposed portions P50a and the exposed portions P50b.

Referring to FIGS. 6A, 6B, and 6C, the process ST220 for forming a pattern P60 of the bus electrodes 31b and 32b includes a process ST221 for laminating a bus electrode film 61 on the exposed photopolymer pattern P50 (FIG. 6A), a process ST222 for removing a carrier film 62 from the bus electrode film 61 (FIG. 6B), and a process ST223 for firing the pattern P60 of the bus electrodes 31b and 32b of the bus electrode film 61 (FIG. 6C).

In the bus electrode film laminating process ST221 of FIG. 6A, a sheet of the bus electrode film 61 is laminated on the exposed photopolymer pattern P50 by applying pressure to the bus electrode film 61 using a roller 63. The bus electrode film 61 includes 95% by weight or more of Ag and less than 5% by weight of an organic binder. The Ag is formed in a crystalline structure to form the bus electrodes 31b and 32b, each having a thickness of 0.5-1 μm such that the bus electrodes 31b and 32b extend about 0.5 μm to 1 μm from the front substrate 20 to the rear substrate 10. When compared to a case in which bus electrodes are formed using a paste having 70% by weight of solid powder and 30% by weight of an organic material, the content of the Ag of the bus electrodes 31b and 32b according to aspects of the present invention is relatively high. That is, as compared with the 70% by weight of the solid powder (Ag: 65% by weight, frit: 5% by weight), the bus electrode film 61 has a higher content of the Ag. In addition, the bus electrodes 31b and 32b are thinner compared to conventional bus electrodes having a thickness of about 1 μm to 3 μm.

In the carrier film removing process ST222 of FIG. 6B, the carrier film 62 is removed from the bus electrode film 61. At this point, first conductive portions 61a facing the non-exposed portions P50a of the photopolymer pattern P50 are removed together with the carrier film 62. However, second conductive portions 61b facing the exposed portions P50a of the photopolymer pattern P50 remain attached to the exposed portion P50b of the photopolymer pattern P50 of the photopolymer 51. Therefore, the bus electrode pattern P60 is formed on the photopolymer pattern P50 by the second conductive portions 61b of the bus electrode film 61 that corresponded to the exposed portions P50b of the pattern P50 of the photopolymer 51.

In the bus electrode pattern baking process ST223 of FIG. 6C, the second conductive portions 61b of the photopolymer 51 are baked or fired to form the bus electrode pattern P60 using the second conductive portion 61b disposed on the exposed portions P50b of the pattern P50 of the photopolymer 51. As such, the bus electrode pattern P60 forms black/white integrated bus electrodes 31b and 32b. To achieve this, the bus electrodes 31b and 32b include cobalt oxide and/or ruthenium oxide such that the bus electrodes 31b and 32b may include one of a cobalt oxide, one of a ruthenium oxide, or a mixture of cobalt oxide and ruthenium oxide. The black/white integrated bus electrodes 31b and 32b makes the process simpler compared to a process in which the black layer and the white layer are individually formed. However, when a ratio of the black color (resulting from the cobalt oxide or ruthenium oxide) to the white color (resulting from the crystalline silver) of the bus electrodes 31b and 32b is too high, the line resistance increases. In contrast, when a ratio of the black color to the white color is too low, the room contrast ratio is deteriorated. Therefore, there is a need to properly adjust the ratio of the black color to the white color. The content ratio between the material components (e.g., a ratio of crystalline silver and cobalt oxide or a ratio of crystalline silver and ruthenium oxide) may be determined through a process of experimentation.

As described above, in the plasma display panel according to aspects of the present invention, as the bus electrodes are formed in a black/white integrated structure through a dry process, the manufacturing process can be simplified and the time to manufacture the plasma display panel can be reduced. Further, environmentally harmful material used manufacturing plasma display panels can be reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel comprising:
first and second substrates facing each other and spaced apart from each other;
barrier ribs disposed between the first and second substrates to define discharge cells;
an address electrode formed on the first substrate and extending in a first direction; and
first and second electrodes formed on the second substrate and extending in a second direction to cross the first direction,
wherein each of the first and second electrodes comprises:
a transparent electrode formed on the second substrate, and
a bus electrode formed on the transparent electrode,
wherein the bus electrode comprises a material including a white crystalline silver (Ag) and a black material.

2. The plasma display panel of claim 1, wherein the bus electrode includes 95% by weight or more of the Ag.

3. The plasma display panel of claim 2, wherein the bus electrode includes less than 5% by weight of binder.

4. The plasma display panel of claim 1, wherein the bus electrode has a thickness of 0.5 μm to 1 μm.

5. The plasma display panel of claim 1, wherein the bus electrode includes one of a cobalt oxide or a ruthenium oxide, or combinations thereof.

6. A method of manufacturing a plasma display panel, comprising:
forming an address electrode, a dielectric layer, a barrier rib, and a phosphor layer on a first substrate;
forming a transparent electrode, a bus electrode, a dielectric layer, and a protective layer on a second substrate;
sealing the first and second substrates together;
exhausting a remaining gas from a space between the first and second substrates; and
filling a discharge gas in the space between the first and second substrates,
wherein the forming of the bus electrode on the second substrate comprises:
forming a photopolymer pattern on the second substrate, and
forming a bus electrode pattern on the photopolymer pattern.

7. The method of claim 6, wherein the forming of the photopolymer pattern comprises:
laminating a photopolymer sheet on the second substrate;
exposing the laminated photopolymer sheet in a predetermined pattern; and
removing a cover film from the photopolymer sheet.

8. The method of claim 7, wherein the laminating of the photopolymer sheet is performed by applying heat and pressure using a roller.

9. The method of claim 6, wherein the forming of the bus electrode pattern comprises:
laminating a bus electrode film sheet on the exposed photopolymer pattern;
removing a carrier film from the bus electrode film sheet so that a first conductive portion of the bus electrode film sheet facing the non-exposed portion of the photopolymer pattern is removed together with the carrier film and a second conductive portion of the bus electrode film sheet facing the exposed portion of the photopolymer pattern remains attached to the exposed portion; and
firing the second conductive portion and the photopolymer to form a bus electrode pattern using the second conductive portion.

10. The method of claim 9, wherein the laminating of the bus electrode film is performed by applying pressure using a roller.

11. A method of forming bus electrodes for a display panel, the method comprising:
laminating a photopolymer sheet on a substrate;
exposing the photopolymer sheet to electromagnetic radiation through a photomask;
laminating a bus electrode film and a carrier film on the exposed photopolymer; and
removing the carrier film,
wherein portions of the bus electrode film corresponding to non-exposed portions of the exposed photopolymer are removed with the carrier film.

12. The method of claim 11, further comprising firing remaining portions of the bus electrode film to form the bus electrodes.

13. The method of claim 11, wherein the laminating the photopolymer sheet comprises disposing a cover film on the photopolymer sheet, and applying heat and pressure to the cover film.

14. The method of claim 11, wherein the laminating the bus electrode film and the carrier film comprises applying pressure to the carrier film.

15. The method of claim 11, wherein the bus electrodes are a mixture of both black and white materials.

16. The method of claim 15, wherein the white material is a crystalline silver.

17. A plasma display panel, comprising:
a front substrate and a rear substrate disposed to face each other;
barrier ribs disposed between the front substrate and the rear substrate to define discharge cells;
phosphor layers disposed in the discharge cells to emit light when excited by a discharge;
address electrodes formed to extend in a first direction across the rear substrate; and
sustain and scan electrodes formed to extend in a second direction across the front substrate and to cross the address electrodes in areas corresponding to the discharge cells,
wherein the sustain and scan electrodes comprise:
transparent electrodes disposed in the areas corresponding to the discharge cells; and
bus electrodes formed by the method of claim 11.

18. The plasma display of claim 17, further comprising:
a dielectric layer to cover the sustain and scan electrodes and the front substrate; and
a protective layer to cover the dielectric layer.
